(19) United States
(12) Patent Application Publication
(10) Pub. No.: US 2014/0251527 A1
(43) Pub. Date: Sep. 11, 2014

(54) METHODS AND APPARATUS FOR CURING RETREADED TIRES

(71) Applicants: E. Bruce Colby, Greenville, SC (US); Dimitri G. Tsihlas, Greer, SC (US); Cesar E. Zarak, Simpsonville, SC (US)

(72) Inventors: E. Bruce Colby, Greenville, SC (US); Dimitri G. Tsihlas, Greer, SC (US); Cesar E. Zarak, Simpsonville, SC (US)

(73) Assignees: MICHELIN RECHERCHE ET TECHNIQUE S.A., Granges-Paccot (CH); COMPAGNIE GENERALE DES ETABLISSEMENTS MICHELIN, Clermond-Ferrand (FR)

(21) Appl. No.: 14/348,289

(22) PCT Filed: Sep. 30, 2011
(86) PCT No.: PCT/US11/54399

§ 371 Date: Mar. 28, 2014

(51) Int. Cl. B29D 30/54

(52) U.S. Cl. CPC B29D 30/542
USPC 156/95; 156/382

(57) ABSTRACT

Embodiments of the invention include methods and apparatus for constraining a tread in a desired arrangement about a tire carcass during retreading operations. Such methods include the steps of providing a annular tire carcass configured for receiving a tread. Such methods also include the step of arranging a tread annularly about the precured tire carcass in a desired position to form an assembled retreaded tire. Such methods further include the step of arranging a retread curing membrane about an outer side of the tread, the curing membrane including an interior surface arranged to engage the outer side of the tread and including one or more protrusions extending from the membrane interior surface and into a void of the outer side of the tread. In other embodiments, a separate insert containing protrusions is arranged between a curing membrane and a tire tread for retread curing operations.

### BACKGROUND OF THE INVENTION

1. Field of the Invention

This invention relates generally to methods and an apparatus for curing retreaded tires, and more particularly, to methods and an apparatus for maintaining treads in a desired arrangement relative a tire carcass during tire retreading operations.

2. Description of the Related Art

Retreaded tires are commonly manufactured by affixing a new tread atop an existing tire carcass. A curing process is performed to secure the tread to the carcass. In preparation for the curing process, a curing membrane or envelope is arranged about the tread to maintain the tread in a desired position atop the tire carcass and to create a seal between the retreaded tire assembly and the curing membrane. A bonding layer may be interposed between the tread and the tire carcass to promote bonding. The area between the curing membrane and the tread is then placed under vacuum pressure to substantially remove the air between the curing membrane and the tire assembly. The retread tire assembly with curing membrane is placed within a curing chamber, which often referred to as an autoclave, to bond the tread to the tire carcass, where the membrane-covered assembly is exposed to heat and pressure according to a desired curing law.

However, voids arranged along an outer, ground-engaging surface of the tread, such as circumferential grooves, may tend to close as the tread is exposed to the vacuum pressure and/or curing pressure. Another problem arises when the bottoms of the same grooves, when thin, may deform and raise upwardly into the groove due to their exposure to vacuum forces and/or due to the tread width compressing laterally during the curing process. This can also reduce void volume and alter the form of the void, which may also create non-uniformities below the tread. This compression problem is compounded when bonding material becomes more malleable or fluid as the assembly is heated during the curing process. Another issue compounding this situation is when a portion of the tread is uncured since the uncured tread may also become more malleable or fluid when the assembly is heated during the curing process.

Therefore, there is a need to better maintain the shape and volume of the voids arranged along an outer, ground-engaging surface of the tread. There is also a need to better stabilize and maintain the shape and arrangement of the tread and/or maintain the curing membrane positionally relative the tread.

### SUMMARY OF THE INVENTION

Particular embodiments of the present invention include methods and apparatus for stabilizing the process of retreading a tire carcass. Such methods include the steps of providing an annular tire carcass configured for receiving a tread. Such methods also include the step of arranging a tread annularly about the precured tire carcass in a desired position to form an assembled retreaded tire. Such methods further include the step of arranging a retread curing membrane about an outer side of the tread, the curing membrane including an interior surface arranged to engage the outer side of the tread and including one or more protrusions extending from the membrane interior surface and into a void of the outer side of the tread.

Particular embodiments of such apparatus include a retread membrane for use in retread tire curing operations. Such apparatus includes the membrane being configured for arrangement about a tire tread arranged about a tire carcass, the retread membrane includes an annular body comprising a length extending in an annular direction, a width extending laterally, a thickness extending between outer and inner surfaces of the annular body, and one or more tread-engaging protrusions extending inwardly from the inner surface for engagement with a tread void.

The foregoing and other objects, features and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

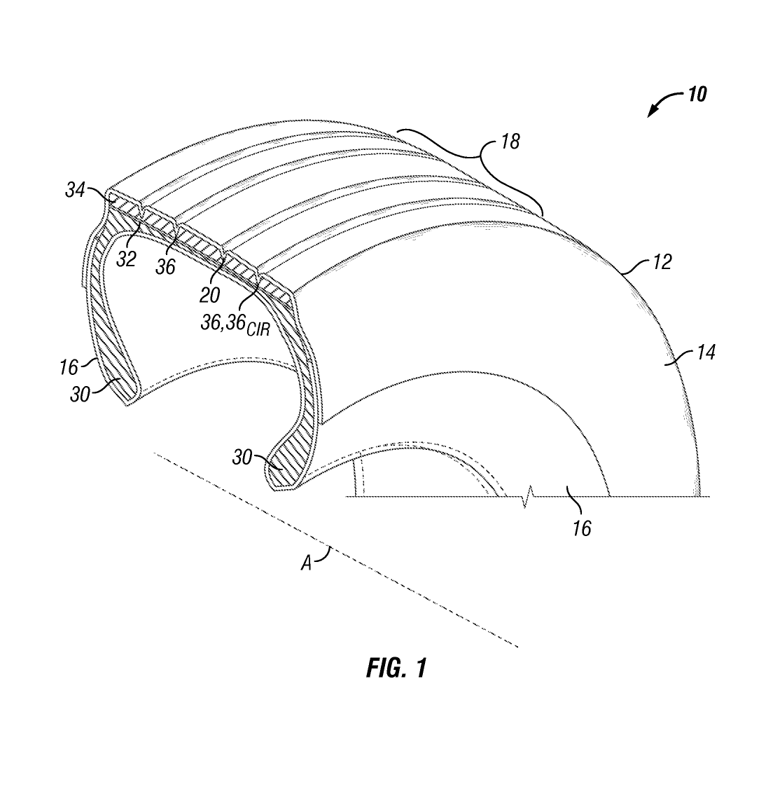

FIG. 1 is a partial perspective view of a ribbed curing membrane positioned about an outer, ground-engaging tread surface of a retreaded tire assembly in an installed arrangement, where a pressurization compartment arranged between the curing membrane and the tread is placed under vacuum pressure according to an exemplary embodiment of the invention.

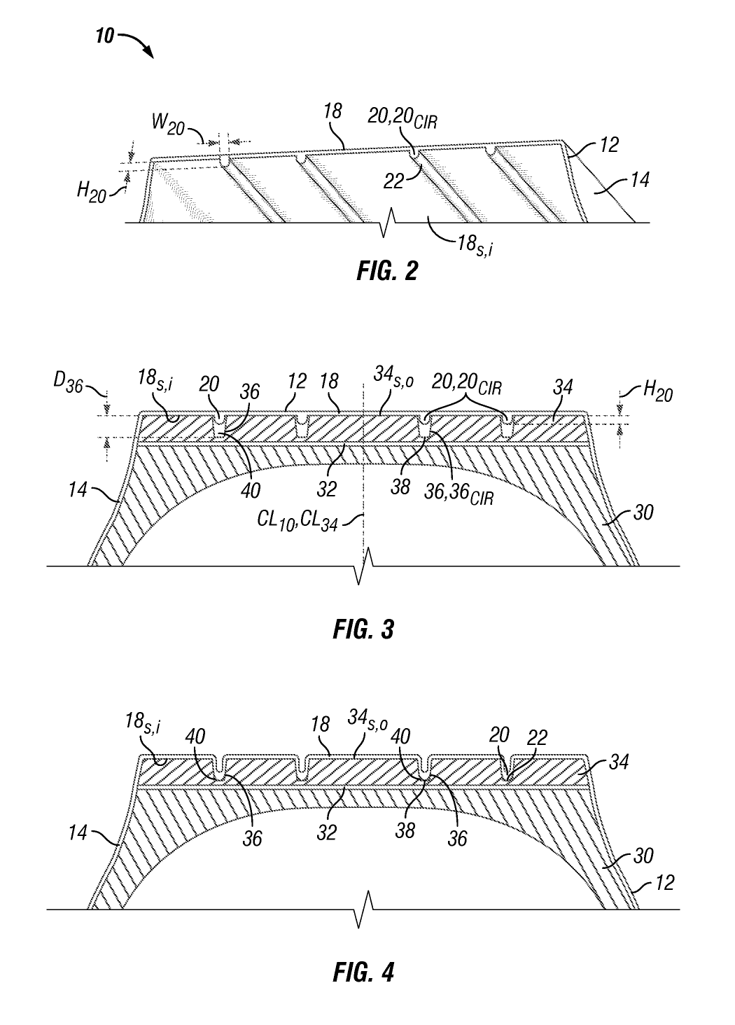

FIG. 2 is a sectioned perspective view of the inside surface of a tread portion of the ribbed curing membrane of FIG. 1, the curing membrane being shown in a relaxed, uninstalled state.

FIG. 3 is a cross-sectional view of a ribbed curing membrane installed about an outer tread surface of a retreaded tire before placing the pressurization compartment under vacuum pressure.

FIG. 4 is a cross-sectional view of the ribbed curing membrane installed about the outer tread surface, where the pressurization compartment is placed under vacuum.

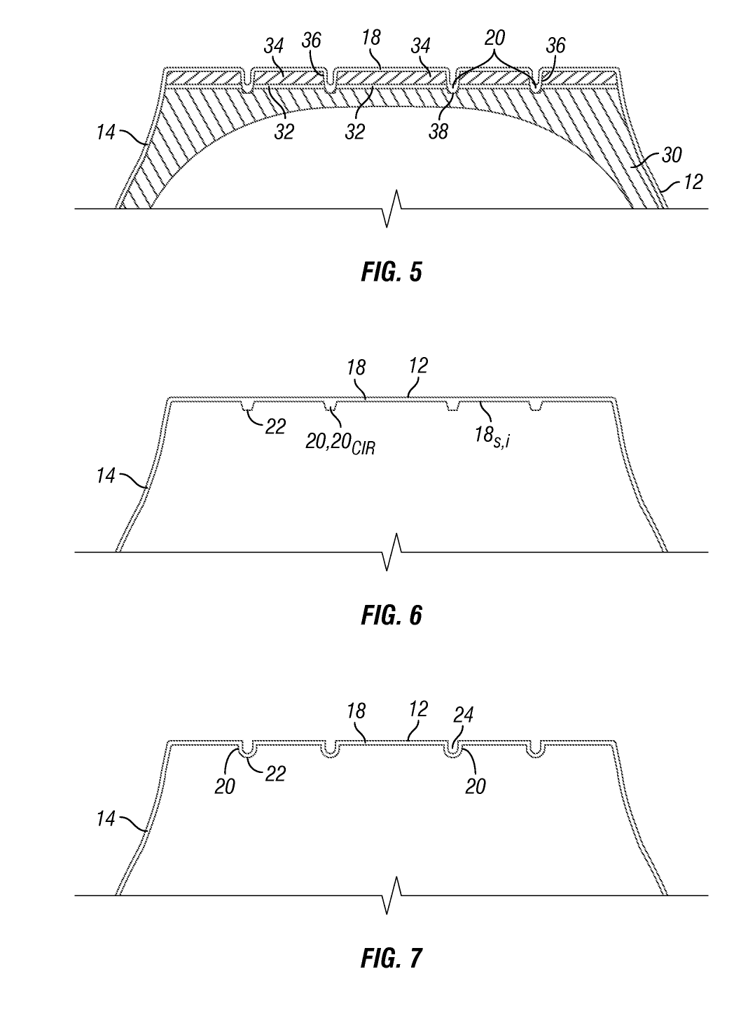

FIG. 5 is a cross-sectional view of a ribbed curing membrane arranged about an outer tread surface of a retreaded tire, where the tread voids comprising grooves extend through a thickness of the tread (comprising multiple, separate strips) and into the tire carcass, according to a particular embodiment of the invention.

FIG. 6 is a cross-sectional view of a ribbed curing membrane in an uninstalled arrangement for use in retread tire curing operations, the ribs having a trapezoidal cross-section according to another embodiment of the invention.

FIG. 7 is a cross-sectional view of a ribbed curing membrane in an uninstalled arrangement for use in retread tire curing operations, the ribs being recessed according to another embodiment of the invention.

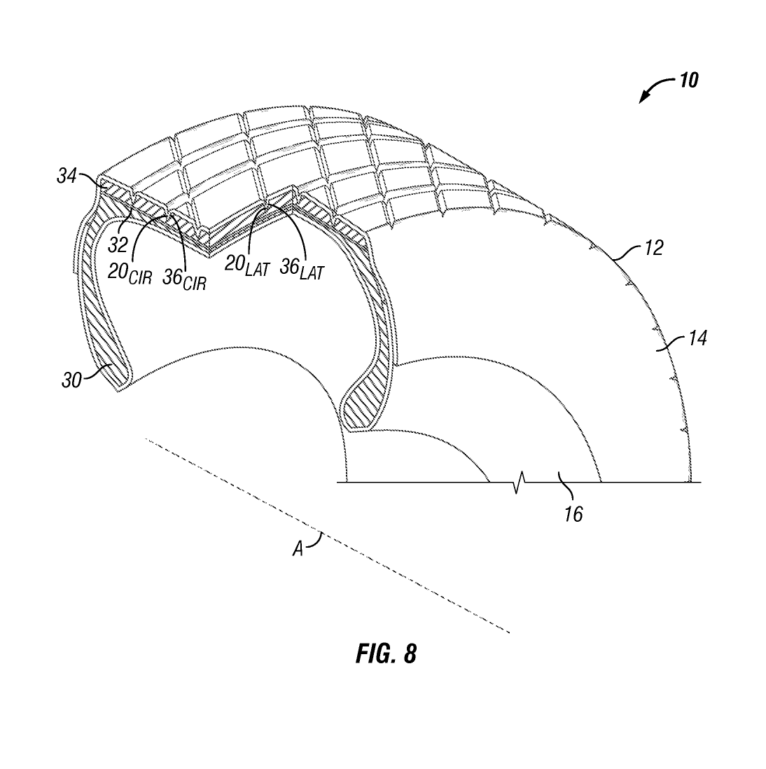

FIG. 8 is a partial perspective view of a ribbed curing membrane arranged about an outer tread surface of a retreaded tire, the tire having voids that include both circumferential and lateral grooves according to another embodiment of the invention.

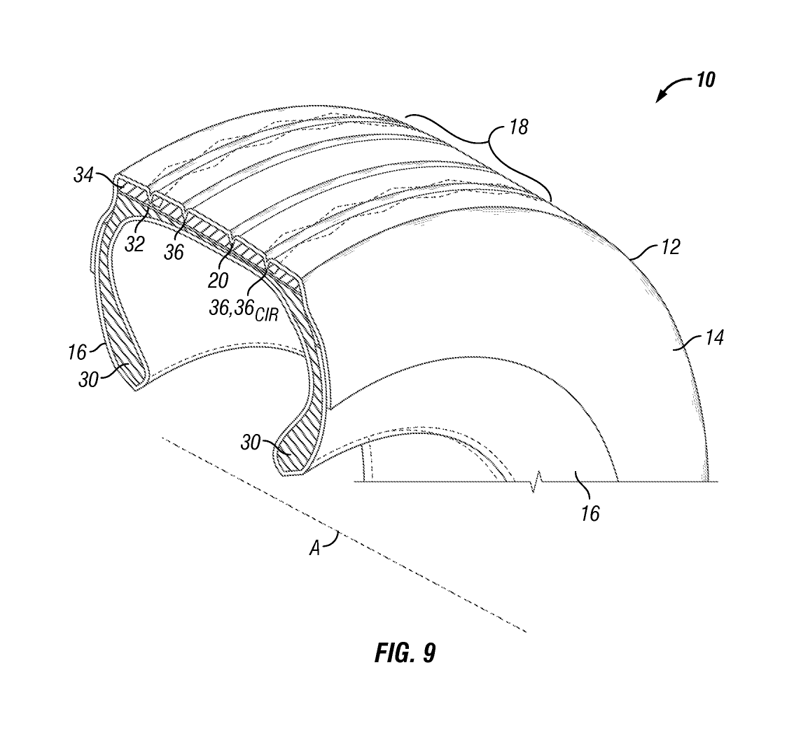

FIG. 9 is a partial perspective view of a ribbed curing membrane positioned about an outer, ground-engaging tread surface of a retreaded tire assembly in an installed arrangement, where a linearly-extending circumferential rib is arranged within each of a pair of tread voids comprising circumferential grooves extending longitudinally in an alternating non-linear or zigzag circumferential path about the tire tread, in accordance with a further embodiment of the invention.

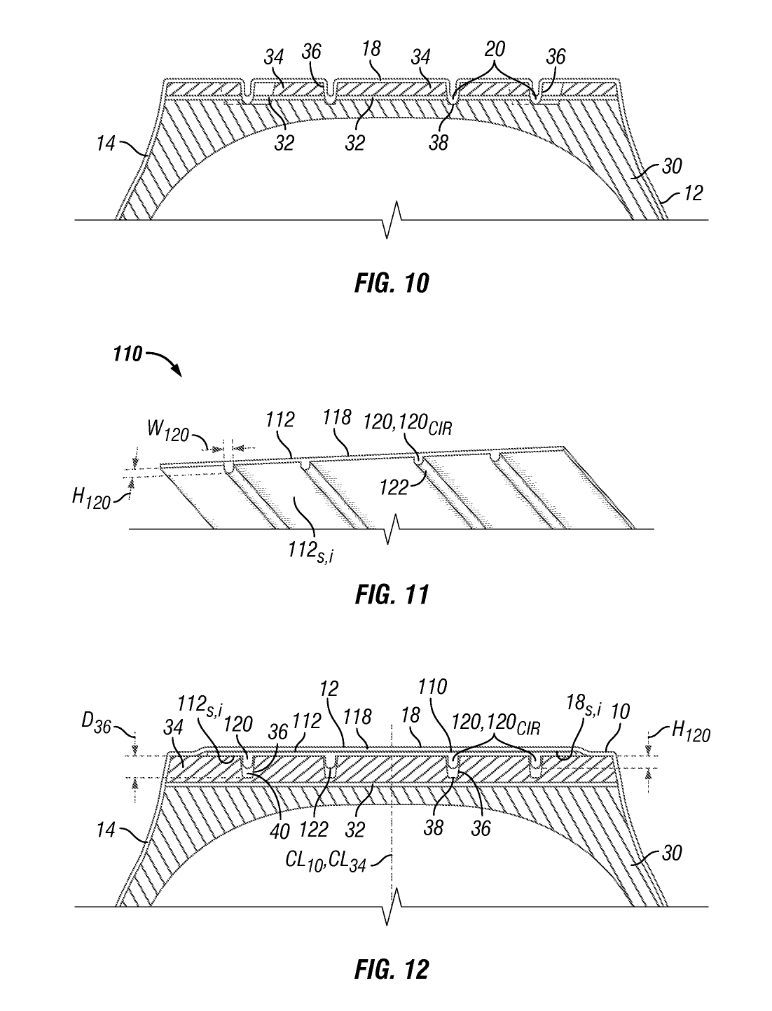

FIG. 10 is a cross-sectional view of the curing membrane and retread tire assembly of FIG. 9 taken along line 9-9.

FIG. 11 is a sectioned perspective view of a ribbed insert for a curing membrane, the insert comprising ribs extending from an inside surface of the insert, the insert being shown in a relaxed, uninstalled state according to another embodiment of the invention.

FIG. 12 is a cross-sectional view of the ribbed curing membrane insert of FIG. 11 installed within a curing membrane and about an outer tread surface of a retreaded tire before placing the pressurization compartment under vacuum pressure.

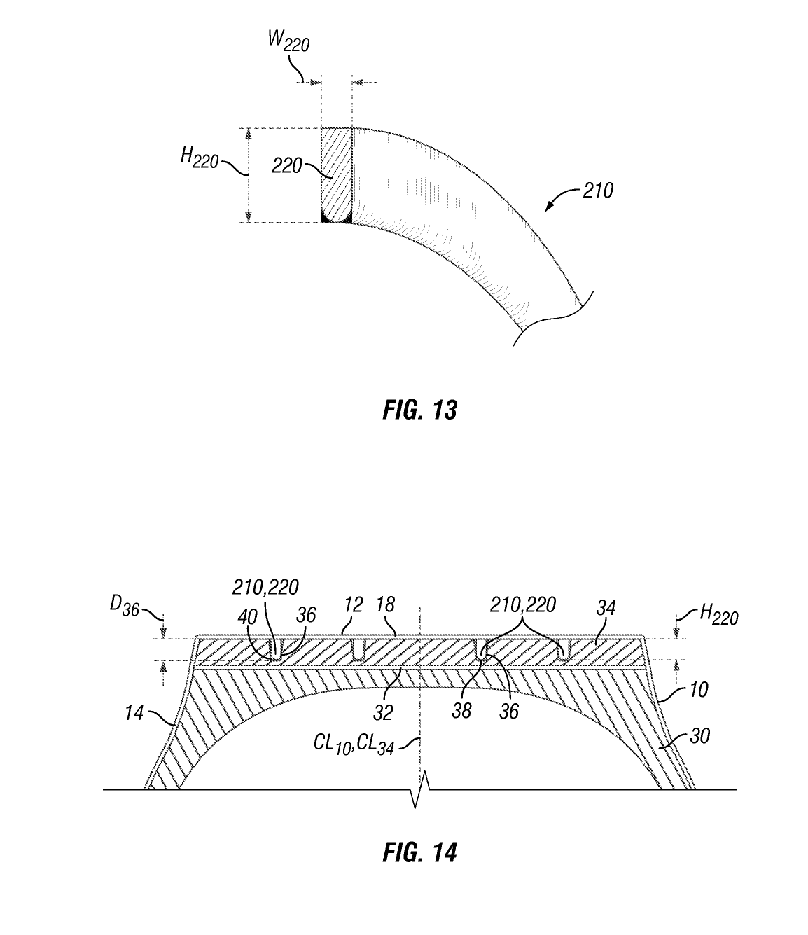

FIG. 13 is a sectioned perspective view of a ribbed insert for a curing membrane, the insert comprising an annular band for arrangement within a tread void, the insert being shown in a relaxed, uninstalled state according to another embodiment of the invention.

FIG. 14 is a cross-sectional view of the ribbed curing membrane insert of FIG. 12 installed within a curing membrane and about an outer tread surface of a retreaded tire before placing the pressurization compartment under vacuum pressure.

### DETAILED DESCRIPTION OF PARTICULAR EMBODIMENTS

Particular embodiments of the present invention provide methods and apparatus for maintaining the shape and volume of a void positioned along a tread outer surface, constraining the tread in a desired arrangement relative the tire carcass (i.e., tire casing), and/or constraining the curing membrane in a desired arrangement relative the tire tread when forming a retreaded tire. By employing such methods and apparatus, the shape, volume, and arrangement of voids positioned along the tread outer surface are better maintained. Because of this, the width of the tread may be better maintained when the shape and/or volume of the voids are generally preserved and stabilized. In particular embodiments, such methods and apparatus maintain the tread grooves in an open arrangement and/or in a desired open shape. Further, such methods and apparatus help to maintain a bottom of any such groove in a desired arrangement, such as to generally prevent any substantial lifting, rising, or deflection of the bottom. Such methods and apparatus may also better maintain the alignment of the curing membrane relative the tire tread and/or carcass during the retreading operations.

Such methods may comprise methods for retreading a tire carcass, which may comprise a variety of steps. In particular embodiments, such methods include the step of providing an annular tire carcass configured for receiving a tread. During retreading operations, an existing, a tire is typically prepared by removing at least a portion of the original tread from the tire through an abrading or buffing operation. The remaining portion of the tire is generally referred to as the tire carcass. For example, the tire carcass generally includes a pair of opposing sidewalls each extending radially outward from a bead to a tread portion extending laterally between the sidewalls. It is generally understood that the tire carcass is previously manufactured, that is, previously molded and cured. Any desired tread and tire carcass may be employed. An exemplary tire tread and tire carcass are discussed further below with reference to the figures.

Further steps of such methods may include the step of arranging a tread annularly about an outer circumference of the tire carcass in a desired position to form an assembled retreaded tire, the tread including a recessed void arranged along an outer surface of the tread. Tire retreading generally comprises placing a new tread on the pre-existing tire carcass. The new tread may be molded, and at least a portion thereof fully or partially cured prior to its application upon a tire carcass. Prior to applying the tread to the tire carcass, a bonding material may be arranged between the new tread and the tire carcass to promote adhesion there between. The bonding material may comprise any known material suitable for its intended purpose of for bonding the new tread to the tire carcass. For example, the joining material may comprise an adhesive or material curable by way of vulcanization, such as natural or synthetic rubber or any other elastomeric and/or polymeric material, which is commonly referred to as liaison rubber or cushion gum.

Particular embodiments of such methods may include the step of arranging a retread curing membrane about the outer side of the tread, the curing membrane including an interior surface arranged to engage the outer side of the tread, where a protrusion is arranged within the recessed void of the tread outer side, between the membrane interior surface and the recessed void. A variety of curing membranes is currently employed in the industry and may be employed by the invention. Generally, a curing membrane includes an outer body, shell, or membrane having a tread portion extending annularly to circumscribe the tread. The body includes a thickness and extends widthwise in a lateral or axial direction. The widthwise extension at least extends the full width of the tread. In particular variations, the width of the body may extend further for the purpose of extending further about the tire carcass. The body may comprise one or more sections to achieve its purpose of covering the outer tread surface and becoming sealed to create an interior pressurization compartment between the tread and the curing membrane. Ultimately, the pressurization compartment is placed under vacuum pressure during retread curing operations.

The outer body includes an inner surface arranged to engage an outer surface (i.e., the ground engaging surface) of the tread. In particular embodiments, the inner surface of the curing membrane tread portion includes one or more protrusions extending outwardly from the membrane inner surface. The one or more protrusions are also configured to extend into a void arranged along the outer side of the tread. The protrusions allow the tread void to remain open and maintain its shape to prevent a substantial reduction in the volume of such void and to prevent any substantial deformation of the void. It is understood that the addition of the one or more protrusions to an inner surface of the tread portion of a curing membrane body may be added to any known curing membrane known by one of ordinary skill in the art. An exemplary retread curing membrane is discussed below in conjunction with the figures filed herewith.

While the protrusion may be integral with the curing membrane interior surface, in other embodiments, the one or more protrusions the protrusion forms an annular member independent of the curing membrane, the annular member forming an insert arranged between the curing membrane and the tire tread. This allows the use of the protrusions without having to modify an existing curing membrane or having to purchase a new curing membrane. In more specific embodiments, the protrusions form separate bands or rings each arranged within a circumferential groove of the tread. In yet other embodiments, the one or more protrusions being integral with an outer membrane arranged along the outer surface of the tread, the outer membrane and the one or more protrusion forming an insert arranged between the curing membrane and the tire tread. The insert could be a continuous band extending the full length of the tread or less, such as when the insert is elastic and therefore expandable. The insert could also comprise a discontinuous band formed of separate, independent segments. The insert could also have features extending laterally to engage lateral voids or features of the tread.

Prior to curing the retreaded tire, these methods may include the step of forming a vacuum within the curing membrane after performing the step of arranging the retread curing membrane about the outer side of the tread. Upon performing this step, the protrusions are drawn or pulled into the voids as air is removed from the void, assuming the protrusions are not otherwise sized to extend to a bottom of the recessed void originally upon installation. This permits the protrusions to further access each void and/or to better fill the volume of the recessed void for the purpose of maintaining the void as pressure is applied to the tire tread during retread curing operations.

To form a retreaded tire, the assembled retreaded tire having an uncured bonding layer must be cured to bond the new tread to the tire carcass. Any method known in the art may be employed to cure the retreaded tire assembly to form a retreaded tire. For example, the assembled retreaded tire may be arranged within a curing chamber known as an autoclave, where the tire is at least partially surrounded by air or other fluids heated and pressurized according to desired curing formulas or laws. Accordingly, particular embodiments of methods for tire retreading further include the step of placing the assembled retreaded tire with the curing membrane arranged thereabout into a curing chamber.

It follows that such methods comprise the additional step of curing the retreaded tire within the curing chamber. This may include applying pressurized and heated fluids about the tire, or at least about an outer side of the assembled retreaded tire. This may also include expanding a curing bladder, such as by filling the curing bladder with a heated, pressurized fluid, within a central cavity of the tire carcass. Other variations may be employed based upon the curing system or method employed. In particular embodiments, for example, the uncured, assembled retreaded tire is placed at least partially within the curing membrane or envelope for at least curing operations within a curing chamber. The curing membrane generally engages the outer side or surface of the tire carcass and tread, to form a skin-like member thereon at least extending circumferentially about the tire and laterally between opposing sidewalls and about the tread of the assembled tire. Any known membrane known in the art may be used. For example, one such membrane extends around the entire tire—circumferentially and laterally. By further example, the tire may be mounted on a wheel while a membrane extends from sidewall to sidewall about the tread. Regardless of the membrane employed, a compartment is generally formed between the membrane and the tire (tread and/or tire carcass), which may be pressurized as desired during curing operations. Accordingly, such methods may include the step of inserting the assembled retreaded tire into the flexible curing membrane, the membrane engaging at least a portion of the outer side of the retreaded tire, wherein the one or more protrusions may translate in a radial direction into the void, engage an interior surface of the void, or engage a bottom surface of the void.

Exemplary embodiments of a retread curing membrane for use in performing such methods of retreading a tire carcass are discussed in further detail below. The device(s) shown in the figures are only exemplary of any of a variety of retread curing membrane that may be employed within the scope of this invention.

As discussed above, a retread tire curing membrane is used to arrange and attach a tire tread to a precured tire carcass. Curing membranes may also be referred to as curing envelopes within the industry. With reference to FIG. 1, a retread tire curing membrane 10 is shown arranged about a retread tire assembly to form a retreaded tire during retread tire operations. Generally, the retreaded tire assembly includes a tire carcass 30, a tread 34, and a bonding layer 32 arranged between the tread and tire carcass. The tread 34, comprising an elastomeric material, such as natural and/or synthetic rubber, for example, generally forms a ring and is assembled about an outer circumference of the tire carcass. The tread or portions of the tread may be uncured, precured, or partially cured. Tread 34 often includes voids 36 extending into a thickness of the tread from an outer surface 34_{s,o} of the tread. Such voids 36 may comprise, for example, grooves extending circumferentially and/or laterally along the tread. A bonding layer 32 arranged between the tread 34 and tire carcass 30 facilitates attachment of the tread to the tire carcass. The bonding layer 32 may comprise any known material capable of attaching the tread to the tire carcass, such as an adhesive or a curable elastomer or polymer, such as cushion gum, for example. In particular embodiments, the bonding layer may not be employed, such as when a portion of the tread is uncured or partially cured.

Improvements to retread tire curing membranes will now be discussed with reference to FIGS. 1-10. Within the industry, curing membranes of different designs are employed to form a retreaded tire. For example, any such curing membrane may extend laterally in a widthwise direction partially or completely about the lateral cross-section of a tire. By specific example, with reference to FIG. 1, a curing membrane is shown to extend entirely about the lateral cross-section of the retreaded tire. By further example, a curing membrane may extend partially about the lateral cross-section, such as when the tire is mounted on a rim. Regardless, one consistency between curing membranes is that the curing membrane includes a tread portion extending annularly about the tread. The tread portion is also referred to in the industry as a crown portion. The improvement concerns this tread portion of the curing membrane, and in particular, concerns the additions of protrusions extending radially from an inner surface of the curing membrane tread portion to engage a desired void arranged along an outer surface of the tread.

With reference to the embodiment shown in FIGS. 1-4, curing membrane 10 generally includes a body 12 extending annularly about the retread tire assembly to generally form a ring. Body 12 may comprise one or more sections extending annularly about the tire. In the embodiment shown, body 12 includes two sections comprising an outer sleeve 14 and an inner sleeve 16, each sleeve extending annularly to form a ring. Outer sleeve 14 extends annularly about tread 34, and includes a tread portion 18 extending annularly about an outer surface 34_{s,o} of the tread. The tread portion 18 extends laterally in a widthwise direction. Inner sleeve 16 extends along an inner surface 30_{s,I} of tire carcass 30 and overlaps outer sleeve at each of the widthwise sides of each sleeve 14, 16 to form a body 12 that extends about the lateral cross-section of the retreaded tire assembly to encapsulate said assembly. Once the curing membrane 10 is arranged about the retread tire assembly, a pressurization compartment 38 is formed between the curing membrane and the retread tire assembly. During retreading operations, pressurization compartment 38 is generally placed under vacuum pressure to remove a substantial amount of air within the compartment 38, and to thereby contract and pull the curing membrane 10 into substantial engagement with corresponding surfaces of the retread tire assembly.

Improvements to curing membranes include positioning one or more tread-engaging protrusions (i.e., ribs) along an inner surface of the membrane for extension into a tread void. The addition of the protrusions offers various benefits, such as assisting to maintain the tread voids in an open arrangement during curing operations. This aids in maintaining the void shape and volume to thereby reduce any lateral or circumferential compression of the tread. This is accomplished by placing the protrusion within the recessed tread void, where the width of the protrusion at least partially maintains the recessed tread void in an open arrangement (i.e., an arrangement whereby the recessed void does not substantially close or collapse as the pressure increases about the tread during retreading operations. While the protrusions may not be substantially arranged to contact the bottom of the recessed tread void, the protrusion may ultimately contact the bottom of the recessed tread void as the curing membrane expands or stretches when the area between the tread and the curing membrane is placed under vacuum pressure. This causes the protrusions to be pulled into the recessed tread void. By reducing lateral compression of the void, local translation of the tread relative the tire carcass is also reduced. Yet another benefit includes engaging the bottom of any tread void to assist in resisting any deformation or buckling of a bottom of the void. Yet another benefit of the protrusions includes maintaining the curing membrane in a desired arrangement relative the tread.

With reference to FIGS. 1-2, curing membrane 10 includes one or more tread-engaging protrusions 20 extending outward from an inner surface 18_{s,I} of tread portion 18. Said protrusions 20 extend outwardly in a radially inward direction relative a rotational axis A of the retread tire assembly/tire carcass 30 by a distance referred to as height H₂₀. Said protrusions 20 also extend lengthwise along said inner surface 18_{s,I}. With reference to FIGS. 2-3, protrusions are further defined as having a cross-sectional shape extending perpendicular to said lengthwise direction, the cross-sectional shape having a width generally forming a width W₂₀ of the protrusion 20.

Said protrusions 20 are generally sized, shaped, and arranged to extend into a void 36 arranged along the tread outer surface 34_{s,o} when the curing membrane 10 is installed or arranged about the retreaded tire assembly. Accordingly, the size, shape, and arrangement of the protrusions 20 may depend, at least in part, upon the voids 36 arranged within the tire tread outer surface 34_{s,o} about which the curing membrane will be installed. As curing membrane 10 is typically constructed of an elastic material, including elastomeric, polymeric, natural or synthetic rubber, protrusions 20 may be formed of like material. Still, in other variations, it is appreciated that protrusions 20 may be formed of any other desired, non-elastic material. Accordingly, protrusions 20 may be formed separately and subsequently affixed to curing membrane 10 or may be formed monolithically with curing membrane.

As discussed above, a void 36 may comprise any tread void, including a groove. For example, with reference to FIGS. 1-2, voids 36 comprising circumferential grooves 36_{cir} are shown, where such grooves each generally extend lengthwise within a plane extending normal to rotational axis A. In other words, circumferential grooves 36_{cir} are shown to extend parallel to, or at an angle of approximately zero degrees relative to, tread centerline CL₃₄. Tread centerline CL₃₄ is arranged within a plane extending normal to rotational axis A. By further example, with reference to FIG. 8, voids 36 comprising lateral grooves 36ₗₐₜ are also shown, where such grooves extend lengthwise in a lateral direction across the tread relative tread centerline CL₃₄ and/or circumferential groove 36_{cir}. Accordingly, with reference to FIGS. 1, 2, and 8, corresponding circumferential protrusions 20_{cir} and lateral protrusions 20ₗₐₜ may be provided and arranged to extend into corresponding tread grooves 36_{cir} and 36ₗₐₜ, respectively. And because a groove 36 may extend in any lengthwise direction relative tread centerline CL₃₄, any protrusion 20 may extend also extend lengthwise any direction relative a curing member centerline CL₁₀ or tread centerline CL₃₄.

With further regard to the lengthwise extension of protrusions 20, with reference to FIGS. 1, 2, and 8, each protrusion 20 is shown to extend linearly along the curing membrane's curved inner surface 18_{s,I}. In other words, each protrusion extends laterally in a constant rate or angle. In other variations, however, because the each protrusion 20 may correspond to any void 36 arranged along inner surface 18_{s,I}, protrusions 20 may instead extend lengthwise in any non-linear path, such as a zigzag or curvilinear path, along the curing membrane's curved inner surface 18_{s,I}. With reference to FIGS. 9 and 10, for example, recessed voids 36 include a pair of circumferential grooves extending longitudinally in a nonlinear, alternating path (also referred to as a zigzag path) about the tire tread. In this instance, the path extends in a path that, in combination with its width, allows a linear circumferentially extending protrusion 20 to extend there through. In other arrangements, the circumferentially extending protrusion 20 may extend in a nonlinear path similar or identical to the non-linearly extending groove 36. It is also appreciated that each lengthwise extension of a void 36 may extend continuously as shown in FIGS. 1, 2, and 8, or extend non-continuously to form multiple voids arranged in a linear or non-linear path, such as to form an array of voids, for example. Other arrangements of protrusions 20 are also possible depending upon the tread employed.

Each protrusion 20 has a cross-sectional shape, which extends perpendicular to a lengthwise extension of said protrusion. With reference to FIGS. 2-3, the cross-sectional shape is generally U-shaped, comprising a mass which tapers from a maximum width W₂₀ at its junction with inner surface 18_{s,I} to a rounded terminal end 22 of the protrusion. It is appreciated, however, that any cross-sectional shape may be employed, which may generally represent the cross-sectional shape of any groove 36 into which said protrusion may extend. By example, with reference to FIG. 6, the cross-sectional shape forms a trapezoid. By further example, a protrusion may have a triangular shape. The cross-sectional shape of a protrusion 20 may be selected to provide a particular shape when deformed under vacuum pressure contained within pressurization compartment 40. Further, the cross-sectional shape may be selected to generally fill the recessed void 36, or only a portion thereof. With reference to FIG. 4, for example, the cross-sectional shape of the protrusion 20 is selected to generally fill the recessed void 36 (i.e., the groove) although the cross-sectional shape is not identical to the cross-sectional shape of the void. However, in other variations, the cross-sectional shape of the protrusion and the void may be substantially the same, where the cross-sectional shape of the protrusion—whether in a deformed shape (i.e., when deformed by way of vacuum pressure arranged within the pressurization compartment) or in an undeformed shape (i.e., when installed upon the tire tread without any vacuum pressure). It follows that the size of the cross-sectional shape of the protrusion and the void may also be equal.

It is also appreciated that the protrusion may comprise a solid mass extending from tread portion 18, such as is represented by the embodiment of FIGS. 2-3, or may be hollow or recessed. For example, with reference to FIG. 7, the U-shaped cross-sectional shape includes a recess 24 extending inward from the outer side of curing membrane 10. This provides a more uniform thickness along the perimeter of the protrusion. By providing a recess or a hollow portion, the thickness of the protrusion may be controlled, which in turn can be used to control the rigidity or elasticity of the protrusion and the ability of the protrusion. This allows a protrusion to extend more or less into a recessed tread void 36 as vacuum pressure is introduced into the pressurization compartment 40 arranged between the curing membrane and the retreaded tire assembly. The solid or thicker cross-sectional shapes may more rigidly engage void 36, while hollow or thinner cross-section shapes may exhibit more flexibility or undergo increased deformation when exposed to vacuum pressure.

As stated above, with reference to FIGS. 2-3, each protrusion 20 has a width W₂₀. In particular embodiments, protrusion width W₂₀ is equal to or less than the width W₃₆ of a corresponding void 36. It is possible that the protrusion width W₂₀ may be greater than void width W₃₆, as the protrusion width W₂₀ may decrease to a desired width as it is drawn into the void 36 when the compartment is placed under vacuum pressure (which is discussed further below).

Also stated above, with reference to FIGS. 2-3, each protrusion 20 extends outwardly from inner surface 18_{s,I} by a distance H₂₀. Because the extension of each protrusion 20 into each void 36 may increase when compartment 40 is placed under vacuum pressure, in particular embodiments, the distance H₂₀ of each protrusion may be generally equal to or less than the depth D₃₆ of the corresponding void into which the protrusion is arranged to extend. The protrusions 20 shown in FIGS. 2-3 extend a distance H₂₀ from inner surface 18_{s,I} that is less than the depth of each groove 36. Further, the protruding distance H₂₀ of each protrusion 20 may be selected such that when the protrusion and/or curing membrane deforms and elongates or stretches as the compartment 40 is placed under vacuum pressure, the terminal end 22 of each protrusion 20 contacts a bottom 38 of each corresponding recessed tread void 36. By doing so, the protrusions 20 may reduce any buckling of the recess bottom (e.g., a bottom of a groove), which may be thin and/or less rigid and therefore more susceptible to deformations and buckling due to pressures created under the tread 34 as any bonding material 32 becomes malleable during tire curing operations. By engaging the void bottom, the protrusion may resist the forces acting upon the recess bottom. It is also appreciated that by not extending the interior protrusions 20 fully into a recess, the curing membrane 10 may be adaptable to similar tread patterns having recessed voids 36 of different depths, meaning that the recesses may be of similar geometry except that the depth of said recesses may be different amongst different treads.

As suggested above, the tire tread 34 and carcass 30 may be bonded together according to any known method to form a cured retreaded tire. In one example, with reference now to FIG. 3, curing membrane 10 is arranged about an outer side of tread 34 to form a pressurization compartment 40 between the curing membrane 10 and the tread 34, whereby the protrusions 20 are aligned to extend within particular recessed tread voids. Subsequently, with reference to FIG. 4, pressurization compartment 40 is placed under vacuum pressure. This may cause protrusions 20 to extend further into each corresponding recessed tread void 36, which may or may not result in the terminal end 22 of each protrusion contacting a void bottom 38. Curing membranes 10 incorporating protrusions 20 may be used in conjunction with treads 34 that do not have void bottoms. With reference to FIG. 5, in such instances, for example, treads may comprise separate, independent strips of tread material spaced laterally along a tire carcass to form a void in conjunction with the tire carcass, whereby the void bottom is arranged along the tire carcass. In this instance, when tread strips are used, the ribbed curing membrane also maintains the desired alignment and arrangement of independent, spaced apart components of the tread, such as tread strips for example.

While protrusions may be formed along the interior side of a curing membrane, in other embodiments, the protrusions are independent of the curing membrane and instead form an insert positioned between the curing membrane and the tire tread. For example, with reference to FIGS. 11-12, an insert 110 comprises an elastic outer body or membrane 112 and one or more protrusions 120 extending outwardly from an interior surface 112_{s,I} of outer body 112. Insert 110 and body 112 (also referred to as membrane) includes a width extending laterally relative the tread and a length extending in a circumferential direction of the tire when arranged about the tread. At least a portion of the body 112 comprises a tread portion 118. In particular embodiments, such as in FIG. 12, when the width of body 112 is equal to or less than a width of the tread, body 112 forms the tread portion 118. Protrusions 120, having height H₁₂₀ and width W₁₂₀, may be formed, shaped, and arranged in any manner discussed above in association with protrusions 20 and curing membrane 10. For example, in the embodiment shown, each protrusion 120 comprises a circumferentially-extending protrusion 120_{cir} having a bottom 122. Insert 110 may extend to form a continuous or discontinuous ring, which may be formed of one or more segments, or may have a length less extending than the circumference of tire tread 34. As shown in FIG. 12, insert 110 is positioned between curing membrane 10 and tread 34, bonding layer 32, and tire carcass 30.

With reference now to the embodiment shown in FIGS. 13-14, another insert 210 is shown. Particularly, insert 210 comprises a protrusion 220 forming a ring or band for insertion into any desired tread void, such as a circumferential groove as shown in FIG. 14. More generally, insert 210 and protrusion 220 can be described as forming an annular body extending longitudinally to form a ring, the body having a height H₂₂₀ and width W₂₂₀ configured to extend within a void arranged along an outer side of a tire tread 30. As with protrusions 120, protrusions 220 may be formed, shaped, and arranged in any manner discussed above in association with protrusions 20 and curing membrane 10. For example, protrusions 220 may extend circumferentially in a constant path as shown in FIG. 13-14, or may extend circumferentially in a non-linear path that varies laterally (which is generally described in FIG. 10 in association with protrusion 20 of curing membrane 10). As shown in FIG. 14, each insert 210 is positioned between curing membrane 10 and tread 34, bonding layer 32, and tire carcass 30.

While this invention has been described with reference to particular embodiments thereof, it shall be understood that such description is by way of illustration and not by way of limitation. Accordingly, the scope and content of the invention are to be defined only by the terms of the appended claims.

1. A method for retreading a tire carcass, the method comprising the steps of:
providing an annular tire carcass configured for receiving a tread;
arranging a tread annularly about an outer circumference of the tire carcass in a desired position to form an assembled retreaded tire, the tread including a recessed void arranged along an outer surface of the tread; and,
arranging a retread curing membrane about the outer side of the tread, the curing membrane including an interior surface arranged to engage the outer side of the tread, where a protrusion is arranged within the recessed void of the tread outer side, between the membrane interior surface and the recessed void.

2. The method of claim 1, wherein the protrusion is integral with the curing membrane interior surface.

3. The method of claim 1, wherein the protrusion forms an annular member independent of the curing membrane, the annular member forming an insert arranged between the curing membrane and the tire tread.

4. The method of claim 2, wherein the protrusion is integral with an outer membrane arranged along the outer surface of the tread, the outer membrane and the protrusion forming an insert arranged between the curing membrane and the tire tread.

5. The method of claim 1 further comprising the step of:
forming a vacuum within the curing membrane after performing the step of arranging the retread curing membrane about the outer side of the tread.

6. The method of claim 1, wherein at least one of the one or more protrusions extends in a circumferential direction of the curing membrane.

7. The method of claim 1, wherein at least one of the one or more protrusions extends in a lateral direction of the curing membrane.

8. The method of claim 1, wherein each of the one or more protrusions engage an interior surface of the recessed void after performing the step of forming a vacuum.

9. The method of claim 8, wherein each of the one or more protrusions engage a bottom surface of the recessed void.

10. The method of claim 1, wherein the void comprises a tread groove.

11. (canceled)

12. (canceled)

13. A retread curing membrane for use in retread tire curing operations, the curing membrane being configured for arrangement about a tread arranged about a tire carcass, the retread curing membrane comprising:
an annular body extending lengthwise in an annular direction and having a tread portion configured for engaging a tread, the tread portion comprising a body having a width extending laterally and a thickness extending between outer and inner surfaces of the annular body; and,
one or more tread-engaging protrusions extending outwardly from the inner surface for engagement with a tread void, the one or more tread-engaging protrusions extending outwardly in a radially inward direction relative the annular body.

14. The retread curing membrane of claim 13, wherein at least one of the one or more protrusions extends in a circumferential direction of the curing membrane, and the void comprises a circumferential tread groove.

15. The retread curing membrane of claim 13, wherein at least one of the one or more protrusions extends in a lateral direction of the curing membrane.

16. (canceled)

17. The retread of membrane of claim 15, wherein the tread-engaging protrusions are formed monolithically with the curing membrane.

18. An insert for arrangement between a curing membrane and a tire for retreading operations, the insert comprising:
an annular body extending longitudinally to form a ring, the body having a height and width configured to extend within a void arranged along an outer side of a tire tread, the height of the annular body being substantially equal to the height of the void.

19. The insert of claim 18 further comprising:
an elastic outer membrane extending longitudinally to form a ring, the annular body forming a protrusion extending from an inner side of the outer membrane, the outer membrane being configured to engage the outer side of the tread when the protrusion is arranged within the tread void.

20. (canceled)

21. (canceled)

22. The method of claim 1, where the protrusion is solid.

23. The retread curing membrane of claim 13, where each of the one or more tread-engaging protrusions is solid.

24. The method of claim 1, where a height of the protrusion substantially equals a depth of the void.

25. The retread curing membrane of claim 13, where a height of each of the one or more tread-engaging protrusions substantially equals a depth of each corresponding void.
